(19) United States
(12) Patent Application Publication
(10) Pub. No.: US 2009/0045240 A1
(43) Pub. Date: Feb. 19, 2009

(54) Stapler

(76) Inventors: Chun-Hsien Chiang, Chang Hua (TW); I-Hui Liu, Hemei Chen (TW)

Correspondence Address: Frenkel & Associates, P.C., Suite 330, 3975 University Drive, Fairfax, VA, 22030, US

(21) Appl. No.: 11/893,694

(22) Filed: Aug. 17, 2007

(51) Int. Cl. B25C 5/16; B25C 5/10

(52) U.S. Cl. 227/127; 227/134

(57) ABSTRACT

A stapler has a center of gravity and has a base assembly, a magazine assembly and a trigger assembly. The magazine assembly connects to the base assembly and has a cap. The trigger assembly connects to the base assembly and has a trigger lever and a limiting lever. The limiting lever prevents the trigger lever and the cap from pivoting excessively to keep the center of gravity of the stapler over the base assembly so that refilling the stapler is convenient.

### BACKGROUND OF THE INVENTION

1. Field of the Invention

The present invention relates to a stapler, and more particularly to a stapler that is labor saving and will not turn over when the stapler is opened to install staples.

2. Description of Related Art

Staplers are common in offices and are used to connect separate documents or sheets of paper together. A large percentage of workers stapling documents are female and may not have the strength required for continuous heavy stapling. When stapling documents, office workers must forcefully push the lever of the stapler to make the staple penetrate the sheets of paper or a document. After hundreds of times of stapling day after day, the workers experience aches and pains on the palms or in the fingers. Therefore, a laborsaving stapler has been developed and has a base, a magazine, a trigger assembly and an articulated assembly. The articulated assembly allows a user to staple paper sheets with less effort when compared to a traditional stapler. However, the laborsaving stapler has a complicated structure and therefore has a high cost.

Moreover, inserting staples into the magazine of the laborsaving or traditional stapler requires pivoting the trigger assembly away from the magazine, which causes the laborsaving or traditional stapler to fall over.

To overcome the shortcomings, the present invention provides a stapler to mitigate or obviate the aforementioned problems.

### SUMMARY OF THE INVENTION

The main objective of the invention is to provide a stapler that is laborsaving and will not fall over when the stapler is opened to load staples in the stapler.

A stapler in accordance with the present invention has a center of gravity and comprises a base assembly, a magazine assembly and a trigger assembly. The magazine assembly connects to the base assembly and has a cap. The trigger assembly connects to the base assembly and has a trigger lever and a limiting lever. The limiting lever prevents the trigger lever and the cap from pivoting excessively to keep the center of gravity of the staple over the base assembly.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a stapler in accordance with the present invention;

FIG. 2 is another perspective view of the stapler in FIG. 1;

FIG. 3 is a perspective view of the stapler with in FIG. 1 with top and bottom covers removed;

FIG. 4 is an exploded perspective view of the stapler in FIG. 1;

FIG. 5 is a side view of the stapler in FIG. 3;

FIG. 6 is an operational side view of the stapler in FIG. 3 with the trigger assembly opened;

FIG. 7 is an operational side view of the stapler in FIG. 3 with the trigger assembly depressed to staple paper sheets; and

FIG. 8 is a side view of the stapler in FIG. 5 with force lines indicated.

### DETAILED DESCRIPTION OF THE PREFERRED EMBODIMENT

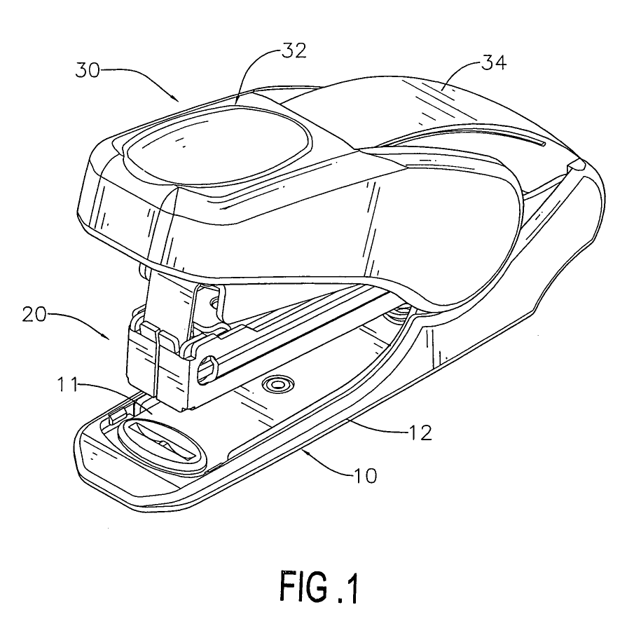

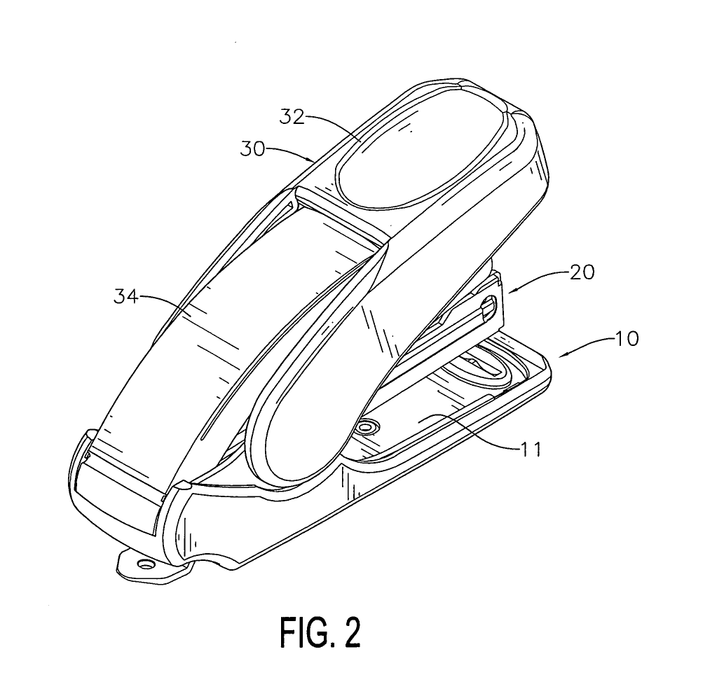

With reference to FIGS. 1 and 2, a stapler in accordance with the present invention has a center of gravity and comprises a base assembly (10), a magazine assembly (20) and a trigger assembly (30). The center of gravity of the stapler depends of the operational configuration of the stapler.

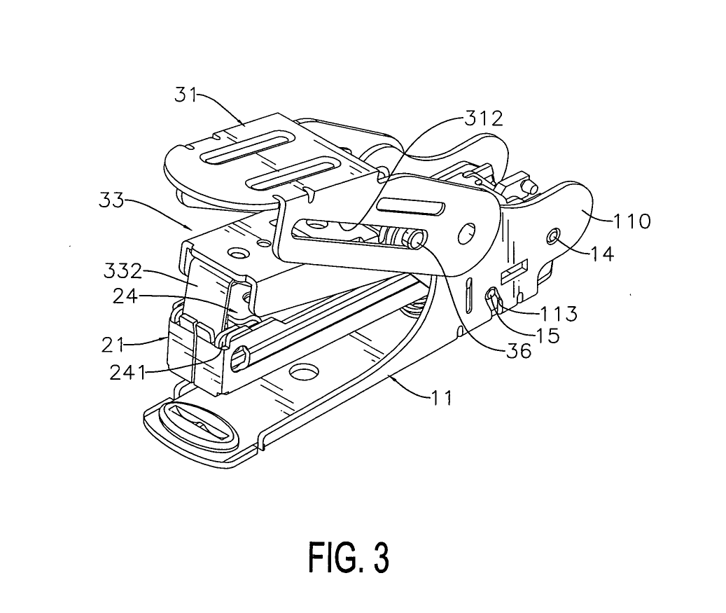

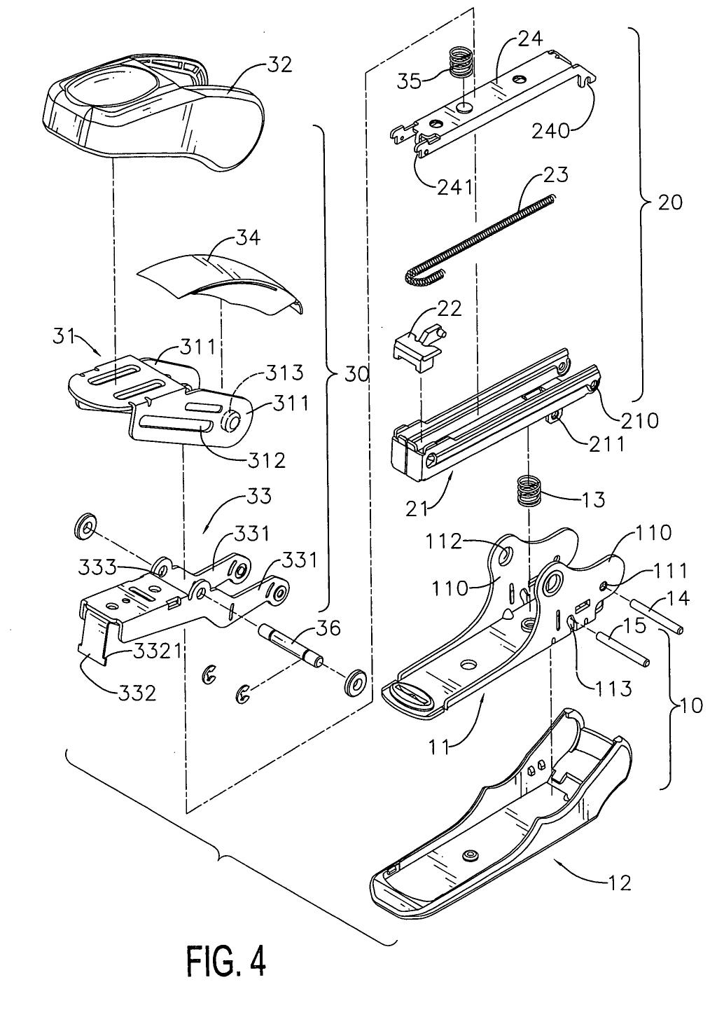

With further reference to FIGS. 3 and 4, the base assembly (10) has a base (11) and may further have a bottom spring (13), a rear pintle (14), a slide pintle (15) and a bottom cover (12).

The base (11) has a front end, a rear end, a bottom bar and two wings (110). The bottom bar has two opposite sides. The wings (110) protrude up from the sides of the bottom bar near the rear end. Each wing (110) may have a rear pivot hole (111), a front pivot hole (112) and a curved slot (113). The front pivot hole (112) is in front of and above the rear pivot hole (111). The curved slot (113) is an arc of a circle and is defined through the wing (110) concentrically with the rear pivot hole (111) serving as a center of the circle.

The bottom spring (13) is mounted on the bottom bar of the base (11).

The rear pintle (14) is mounted through the rear pivot holes (111) in the wings (110).

The slide pintle (15) is mounted through the curved slots (113) and is capable sliding along the curved slot (113).

The bottom cover (12) is mounted under and covers the base (11).

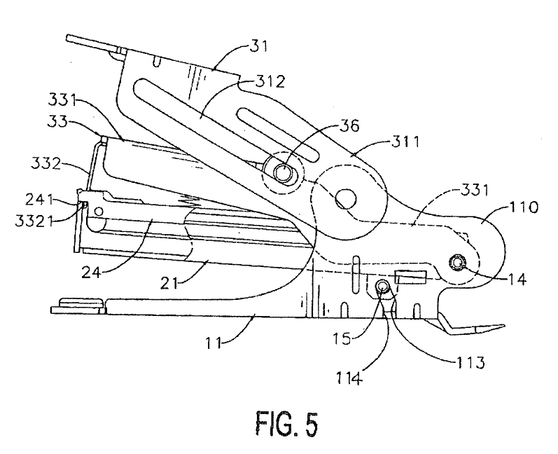

With further reference to FIG. 5, the magazine assembly (20) connects pivotally to the base assembly (10) and has a magazine (21) and a cap (24) and may further have a staple foot (22) and a compression spring (23).

The magazine (21) connects pivotally to the base (11), may press against the bottom spring (13) and has a front end, a rear connecting end and a cavity and may further have a pintle mount. The rear connecting end connects pivotally to and between the wings (110) adjacent to the rear end of the base (11) and may have a pintle hole (210) through which the rear pintle (14) is mounted. The cavity is defined in the magazine (21) and holds staples. The pintle mount is formed on the magazine (21) near the rear connecting end and has a mounting hole (211) mounted around the slide pintle (15). The magazine (21) is held by the slide pintle (15) and is not able to pivot further up when the slide pintle (15) slides up to the end of the curved slots (15).

The cap (24) connects pivotally to the base (11), selectively covers the cavity in the magazine (21) and has a front end and a rear connecting end. The front end of the cap (24) may have two notches (241). The rear connecting end of the cap (24) connects pivotally to and between the wings (110) on the base (10) and may have a recess (240) engaging rotatably with the rear pintle (14).

The staple foot (22) is mounted slidably in the cavity and pushes staples toward the front end of the magazine (21).

The compression spring (23) is mounted in the cavity and biases the staple foot (22) against staples in the magazine (21).

The trigger assembly (30) connects pivotally to the base assembly (10), is pressed to staple paper sheets with staples in the magazine (21) and has a trigger lever (33), a limiting lever (31) and a slide pin (36) and may further have an internal spring (35), a top cover (32) and a gap cover (34).

The trigger lever (33) connects pivotally to the base (11) above the cap (24) and has a front end, a rear end, two opposite connecting tabs (331) and an activating tab (332). The connecting tabs (331) are formed on the trigger lever (33). Each connecting tab (331) has a front end, a rear connection end and an intermediate section. The rear connection end connects pivotally to one of the wings (110) on the base (10), and may have a pintle hole. The pintle hole is mounted around the rear pintle (14). The intermediate section is between the front end and the rear connection end and has a pin hole (333). The activating tab (332) protrudes perpendicularly down from the front end of the trigger lever (33) and selectively extends through the front end of the magazine (21) to press a staple toward the bottom bar of the base (11). The activating tab (332) may have two opposite hooks (3321). The hooks (3321) are formed on the activating tab (332) and selectively engage the notches (241) in the cap (24) so pivoting the trigger lever (33) up also pivots the cap (24) up to open the magazine (21).

The limiting lever (31) connects pivotally to the base (11) above the trigger lever (33), selectively presses the trigger lever (33) down and has a front end, a rear end and two side tabs (311). The side tabs (311) are formed on the limiting lever (31), protrude from the rear end of the limiting lever (31) and form a gap. The gap is formed between the side tabs (311) at the rear end of the limiting lever (31). Each side tab (311) has a rear connection end and a limiting slot (312). The rear connection end connects pivotally to one of the wings (110), is located in front of and above the rear end of the trigger lever (33) and may have a pivot boss (313) protruding inward from the side tabs (311) and mounted rotatably in the front pivot hole (112) in the wing (110). The limiting slot (312) is defined longitudinally through the side tab (311) and has an inner front end and an inner rear end.

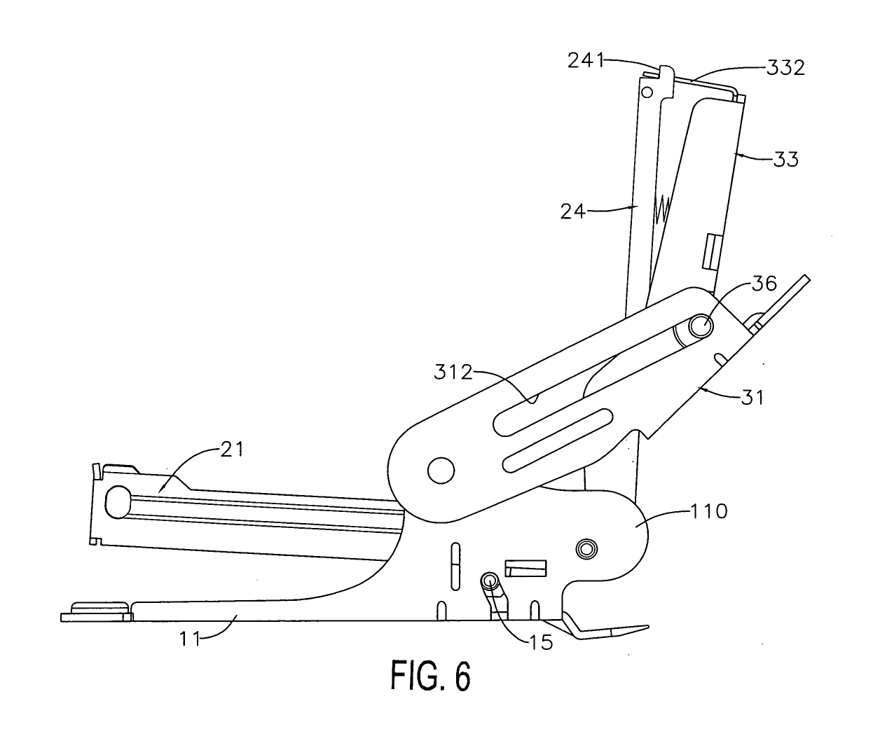

With reference to FIG. 6, the slide pin (36) extends through the pin holes (333) in the trigger lever (33) and the limiting slots (312) in the limiting lever (31) and slides in the limiting slots (312). When the trigger lever (33) and the cap (24) pivot up substantially perpendicular to the base (11), the slide pin (36) presses against the inner front ends of the limiting slots (312) and prevents the trigger lever (33) and the cap (24) from pivoting further away from the magazine (21) and the base (11). The cooperation of the slide pin (36) and the limiting slots (312) prevents the center of gravity of the stapler from over the base (11). Therefore, the opened stapler sitting on a table will not fall over so refilling the magazine (21) with staples is convenient.

The internal spring (35) is mounted between the cap (24) and the trigger lever (33).

The top cover (32) covers the limiting lever (31).

The gap cover (34) covers the gap in the limiting lever (31).

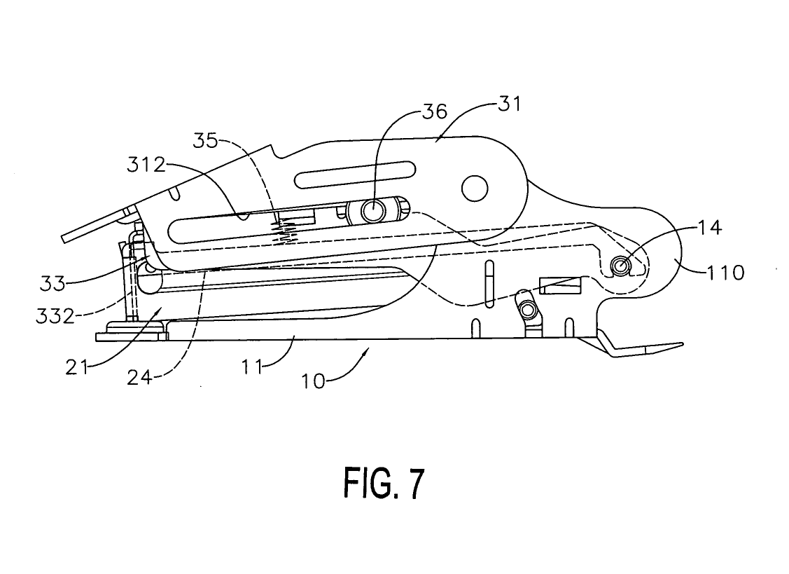

With further reference to FIG. 7, the limiting lever (31) is pushed down to press against and depress the trigger lever (33) and cause the activating tab (332) to press a staple out of the magazine to staple paper sheets on the base (11).

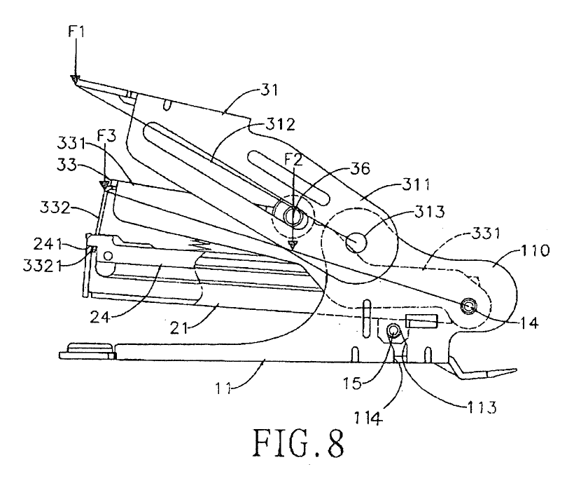

With reference to FIG. 8, equations are used to prove that the stapler is laborsaving and is convenient to use. The equations include an input force (F₁) at the front end of the limiting lever (31), an internal force (F₂) applied at the slide pin (36), an output force (F3) applied at the front end of the trigger lever (33). A ratio of a length of the limiting lever (31) and a distance from the slide pin (36) to the pivot boss (313) is 5 a ratio of the length of the trigger lever (33) and a distance from the slide pin (36) to the rear pintle (14) is 2.

F₁×5=F₂×1; F₂=5F,;

F₃×2=F₂×1; 2F₃=5F₁;

F₃=2.5F₁

Because the output force (F₃) is 2.5 times the input force (F₂), the stapler is laborsaving. Moreover, the limiting trigger (31) prevents the cap (24) and trigger lever (33) from pivoting excessively and keeps the center of gravity of the stapler over the base (11) so refilling the magazine is easy and convenient.

1. A stapler comprising
a center of gravity;
a base assembly having a base having
a front end;
a rear end;
a bottom bar having two opposite sides; and
two wings protruding up from the sides of the bottom bar near the rear end;
a magazine assembly connecting pivotally to the base assembly and having
a magazine connecting pivotally to the base and having
a front end;
a rear connecting end connecting pivotally to and between the wings adjacent to the rear end of the base; and
a cavity defined in the magazine; and
a cap connecting pivotally to the base, selectively covering the cavity in the magazine and having
a front end; and
a rear connecting end connecting pivotally to and between the wings on the base; and
a trigger assembly connecting pivotally to the base assembly and having
a trigger lever connecting pivotally to the base above the cap and having
a front end;
a rear end;
two opposite connecting tabs formed on the trigger lever, and each connecting tab having
a front end;
a rear connection end connecting pivotally to one of the wings on the base; and
an intermediate section located between the front end and the rear connection end and having a pin hole; and
an activating tab protruding perpendicularly down from the front end of the trigger lever and selectively extending through the front end of the magazine;
a limiting lever connecting pivotally to the base located above the trigger lever, selectively pressing the trigger lever down and having
a front end;
a rear end; and
two side tabs formed on the limiting lever and forming a gap between the side tabs, and each side tab having
a rear connection end connecting pivotally to one of the wings, and located in front of and above the rear end of the trigger lever; and
a limiting slot being defined longitudinally through the side tab and having
an inner front end; and
an inner rear end; and
a slide pin extending through the pin holes in the trigger lever and the limiting slots in the limiting lever, being capable of sliding along the limiting slots and selectively pressing against the inner front ends of the limiting slots to prevent the trigger lever and the cap from pivoting further away from the magazine and the base.

2. The stapler as claimed in claim 1, wherein each wing has
a rear pivot hole;
a front pivot hole being in front of and above the rear pivot hole; and
a curved slot being an arc of a circle, being defined through the wing and being concentric with the rear pivot hole serving as a center of the circle;
the base assembly further has
a bottom spring mounted on the bottom bar of the base and pressing against the magazine;
a rear pintle mounted through the rear pivot holes; and
a slide pintle mounted through the curved slots and being capable of sliding along the curved slot;
the rear connecting end of the magazine has a pintle hole through which the rear pintle is mounted;
the magazine further has a pintle mount formed on the magazine near the rear connecting end and having a mounting hole mounted around the slide pintle;
the rear connecting end of the cap has a recess engaging rotatably with the rear pintle;
the rear connection end of each connecting tab of the trigger lever has a pintle hole mounted around the rear pintle; and
each rear connection end of each side tab of the limiting lever has a pivot boss mounted rotatably in the front pivot hole in one of the wings.

3. The stapler as claimed in claim 2, wherein
the front end of the cap further has two notches;
the activating tab has two opposite hooks formed on the activating tab and selectively engaging the notches in the cap; and
the trigger assembly further has an internal spring mounted between the cap and the trigger lever.

4. The stapler as claimed in claim 3, wherein
the base further has a bottom cover mounted under and covering base; and
the trigger assembly further has
a top cover covering the limiting lever; and
a gap cover covering the gap in the limiting lever.
